(19) United States
(12) Patent Application Publication
(10) Pub. No.: US 2018/0119922 A1
(43) Pub. Date: May 3, 2018

(54) DISPLAY DEVICE

(71) Applicants: TRAM, INC., Plymouth, MI (US); KABUSHIKI KAISHA TOKAI RIKA DENKI SEISAKUSHO, Aichi (JP)

(72) Inventors: Hiroaki YAMAGUCHI, Novi, MI (US); Shuri ARAKAWA, Ann Arbor, MI (US)

(73) Assignees: TRAM, INC., Plymouth, MI (US); KABUSHIKI KAISHA TOKAI RIKA DENKI SEISAKUSHO, Aichi (JP)

(21) Appl. No.: 15/337,190

(22) Filed: Oct. 28, 2016

(51) Int. Cl. F21V 9/14; G02B 5/30; F21S 8/10

(52) U.S. Cl. CPC F21V 9/14; F21S 48/2218; F21S 48/21; G02B 5/3041

(57) ABSTRACT

A display device is provided and may include a polarized film assembly disposed in the display device and configured to control a selective displaying of a first graphical image and a second graphical image on the display device. When the display device is actuated, the polarized film assembly may be illuminated such that the first graphical image and the second graphical image are repeatedly and alternately displayed on the display device.

### BACKGROUND

### 1. Field of the Disclosure

The present disclosure relates to the field of display devices. More particularly, the present disclosure relates to display devices that control selection of various vehicle functions and display of the selected vehicle function.

### 2. Background Information

Conventionally, display devices provided in vehicles (e.g., a hazard switch) have been known to flash or blink when a push button is activated. The flashing and blinking alerts the operator that a vehicle function has been activated. For example, as shown in FIG. 3, a conventional hazard switch is shown with a standard hazard light triangle symbol. When the hazard switch is pushed, the hazard light triangle symbol is illuminated ON and OFF in an alternating manner so that the hazard switch flashes and blinks to alert the operator that the hazard lights are on.

### 3. Summary of the Disclosure

In order to alert the operator that the vehicle function has been selected, these conventional push button designs must set the blinking light at a relatively high intensity (e.g., 500 cd/m²) so that the operator can see it against direct sun light. However, with such settings, the blinking and flashing light can be distracting and negatively impact the operator during nighttime driving scenarios (e.g., the driver may be distracted by glare and reflection of the blinking light off of other interior components). Moreover, blinking and flashing indicators have been known to raise the risk of triggering epileptic episodes in drivers and passengers alike. Accordingly, there is a need for an improved display device that simply and clearly displays multiple vehicle functions and/or selected states of a vehicle function while minimizing the negative impact on drivers and passengers caused by distracting flashing and blinking indicators.

According to non-limiting embodiments of the present application, a display device is provided and may include a polarized film assembly disposed in the display device and configured to control a selective displaying of a first graphical image and a second graphical image on the display device. When the display device is actuated, the polarized film assembly is illuminated such that the first graphical image and the second graphical image are repeatedly and alternately displayed on the display device.

According to another non-limiting embodiment, the display device may include at least one light source provided below the polarized film assembly and configured to pass light through the polarized film assembly. When the display device is actuated, the at least one light source is illuminated to repeatedly and alternately display the first graphical image and the second graphical image on the display device.

According to yet another non-limiting embodiment, the at least one light source is a first light source and a second light source, and when the display device is actuated, the first light source and the second light source are repeatedly and alternately illuminated to repeatedly and alternately display the first graphical image and the second graphical image on the display device.

According to a further non-limiting embodiment, the polarized film assembly may include a first polarized film section, and a second polarized film section, where the first polarized film section is spaced from the second polarized film section along a height direction of the display device, where the first polarized film section is a multilayer film and includes at least two absorbing polarized film layers, each film layer including one of the plurality of graphical images, each film layer having a film layer polarization orientation and each film layer polarization orientation being oriented 90° from another film layer polarization orientation of another film layer, and the first polarized film section is stacked along the height direction of the display device. The second polarized film section includes a first absorbing polarized film having a first polarization orientation and a second absorbing polarized film having a second polarization orientation oriented 90° from the first polarization orientation of the first absorbing polarized film, and the first and second absorbing polarized films are disposed along a plane bisecting the polarized film assembly at a position below the first polarized film section. When the display device is actuated, the first polarized film section is repeatedly and alternately illuminated such that the graphical images included on the absorbing polarized film layers are repeatedly and alternately displayed on the display device.

According to a non-limiting embodiment, the polarized film assembly may be configured to prevent boundary edges of each of the first graphical image and the second graphical image from overlapping one another when viewed from an upper surface of the display device.

According to another non-limiting embodiment, the first graphical image and the second graphical image may be superimposed on each other in a concentric manner when viewed from an upper surface of the display device.

Other aspects and advantages of the present disclosure will become apparent from the following description taken in conjunction with the accompanying drawings, illustrated by way of example, the spirit of the invention.

### BRIEF DESCRIPTION OF THE DRAWINGS

The novel features which are characteristic of the various embodiments of the assembly, both as to structure and method of operation thereof, together with further aims and advantages thereof, will be understood from the following description, considered in connection with the accompanying drawings, in which embodiments of the assembly are illustrated by way of example. It is to be expressly understood, however, that the drawings are for the purpose of illustration and description only, and they are not intended as a definition of the limits of the assembly. For a more complete understanding of the disclosure, as well as other aims and further features thereof, reference may be had to the following detailed description of the disclosure in conjunction with the following exemplary and non-limiting drawings wherein:

FIG. 1A shows an exemplary, non-limiting example of a display device, according to aspects of the present disclosure.

FIG. 1B shows a sequential display of the graphical images shown in FIG. 1A when the display device is actuated, according to aspects of the present disclosure.

FIG. 2A shows a partial exploded cross-sectional view of an exemplary, non-limiting embodiment of a polarized film assembly, according to aspects of the present disclosure.

FIG. 2B shows a partial plan view of an exemplary, non-limiting example of an orientation of a polarized film section, according to aspects of the present disclosure.

FIG. 3 is an example of a conventional push button assembly.

### DETAILED DESCRIPTION

In view of the foregoing, the present disclosure, through one or more of its various aspects, embodiments and/or specific features or sub-components, is thus intended to bring out one or more of the advantages as specifically noted below.

Methods described herein are illustrative examples, and as such are not intended to require or imply that any particular process of any embodiment be performed in the order presented. Words such as “thereafter,” “then,” “next,” etc. are not intended to limit the order of the processes, and these words are instead used to guide the reader through the description of the methods. Further, any reference to claim elements in the singular, for example, using the articles “a,” “an” or “the”, is not to be construed as limiting the element to the singular.

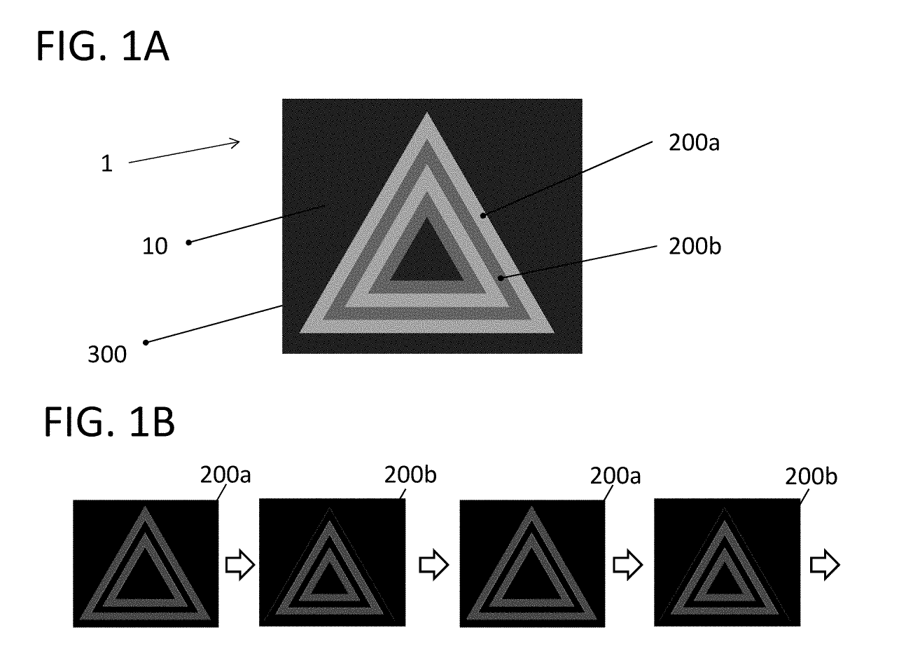

FIGS. 1A and 1B illustrate an example of a display device 1. The display device 1 includes a polarized film assembly 300 including two graphical images 200a-b that can be displayed on an upper surface 10 of the display device 1. In this example, the polarized film assembly 300′ is disposed in the display device 1 such that the first and second graphical images 200a-b are repeatedly and alternately displayed on the upper surface 10 of the display device 1. As shown in FIG. 1A, the polarized film assembly 300 includes two different graphics that appear superimposed on each other in a concentric manner when viewed from the upper surface 10 of the display device 1. When the display device 1 is actuated, the polarized film assembly 300 is illuminated such that the two graphical images 200a-b are repeatedly and alternately displayed on the upper surface 10 of the display device 1.

Thus, as shown, e.g., in FIGS. 1A and 1B, the first graphical image 200a is a triangular hazard/emergency image and the second graphical image 200b is a triangular hazard/emergency image (smaller than the first graphical image 200a) that is superimposed onto the first graphical image 200a in a concentric manner when viewed from the upper surface 10 of the display device 1. As shown in FIG. 1B, when the display device 1 is actuated, the polarized film assembly 300 is illuminated such that the first graphical image 200a and the second graphical image 200b are repeatedly and alternately displayed on the upper surface 10 of the display device 1. While the disclosed display device has been described using the example of a hazard switch, the implementation of the display device is not so limited and thus it is contemplated that other graphical images and/or indicia for other vehicle functions or otherwise (e.g., graphics implemented in an A/C control panel in a home, an alarm system, home appliance operations, etc. . . . ), whether or not they are concentrically arranged, may be employed so long as they are capable of being repeatedly and alternately illuminated and the graphical images do not overlap (e.g., a boundary edge of one graphical image does not overlap the boundary edge of another graphical image when viewed from the upper surface 10 of the display device 1).

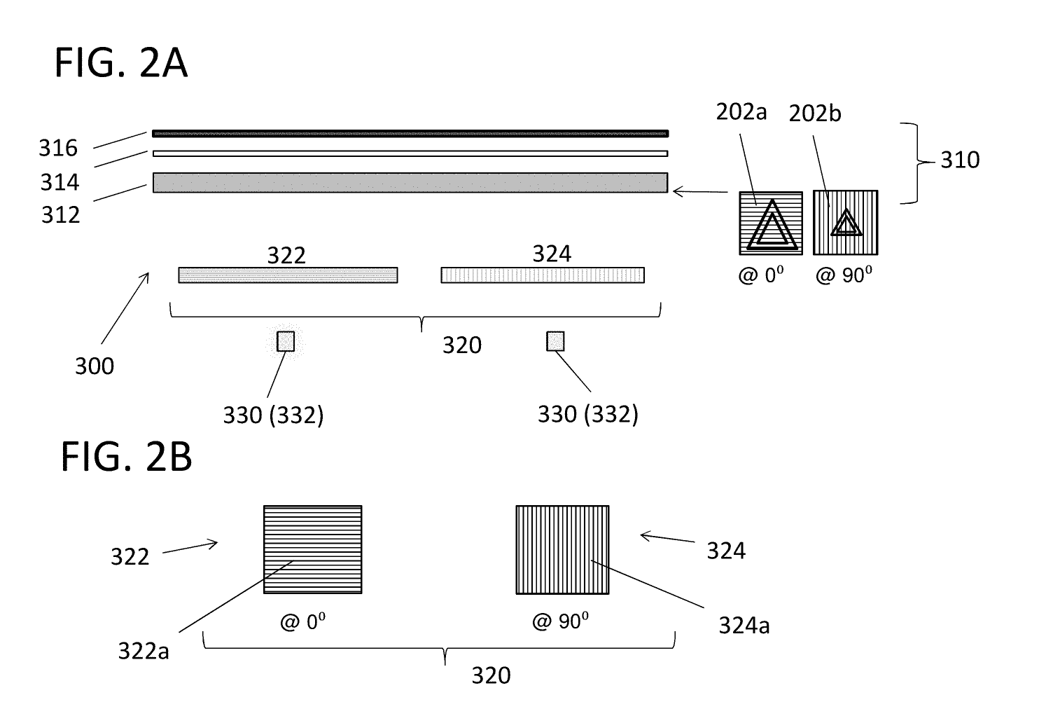

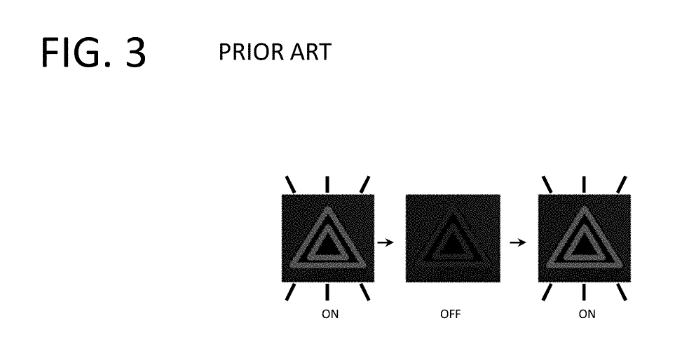

FIG. 2A shows a partial exploded cross-sectional view of the polarized film assembly 300. The polarized film assembly 300 includes a first polarized film section 310 and a second polarized film section 320. The first polarized film section 310 and the second polarized film section 320 are stacked in a height direction of the display device 1. The first polarized film section 310 is also spaced from the second polarized film section 320 in the height direction. In addition to the polarized film assembly 300, the display device 1 includes a light source 330. The light source 330 is provided below the polarized film assembly 300.

As shown in FIG. 2A, the light source 330 includes two LED lights 332. Each LED light 332 is provided below either a first absorbing polarized film 322 or a second absorbing polarized film 324 of the second polarized film section 320 and spaced from the first and second absorbing polarized films 322, 324 in the height direction of the display device 1. The distance or spacing between the second polarized film section 320 and the light source 330 in the height direction is not particularly limited so long as the light passing through the second polarized film section 320 can readily illuminate the first polarized film section 310 to alternately and repeatedly display the graphical images 200a, 200b. In addition, in this embodiment, the color emitted from the light source 330 is also not particularly limited (e.g., blue, yellow, red, purple, green, orange, white, pink, etc. . . . ) so long as the colored light passing through the second polarized film section 320 can readily illuminate the first polarized film section 310 to alternately and repeatedly display the graphical images 200a, 200b.

In polarized film assembly 300, the first polarized film section 310 is a multilayer film and includes an absorbing polarized film layer 312 (including the stacked films with graphical images 200a, 200b), a diffusion layer 314 and a smoke layer 316. When the first polarized film section 310 is assembled, the diffusion layer 314 is disposed between the smoke layer 316 and the absorbing polarized film layer 312 in the height direction of the display device 1. The diffusion layer 314 and the smoke layer 316 are stacked above the absorbing polarized film layer 312 so as to improve the quality of the image seen by the operator. In this regard, the diffusion layer 314 is provided so as to spread light through the entire graphical image for the purpose of ensuring that the graphical images 200a, 200b appear evenly illuminated. When the light source 330 illuminates the first polarized film section 310, some of the emitted light can leak from the graphical image not being displayed and may lead to undesirable ghosting effects or distortion of the graphical image being displayed. Thus, the smoke layer 316 is provided to reduce the effect of any light leakage from the graphical image not being displayed to ensure that only the one graphical image is displayed in the alternate and repeated manner described above.

In addition, while the two different graphical images appear superimposed on each other in a concentric manner when viewed from the upper surface 10 of the display device 1, the graphical images should not overlap so as to prevent unevenness of the graphical image being displayed. In particular, a small amount of light may escape or leak from the film of the graphical image not being displayed. In order to minimize one area of the displayed graphical image from being brighter or dimmer than another area of the displayed graphical image, the graphical images should not overlap to avoid the leaked light from over illuminating any one portion of the displayed graphical image relative to other portions of the displayed graphical image. Thus, as shown, e.g., in FIGS. 1A and 1B, the first graphical image 200a is a large triangular hazard/emergency image on a first absorbing polarized film layer 312 and the second graphical image 200b is a small triangular hazard/emergency image on a second absorbing polarized film layer 312, and the first and second absorbing polarized film layers 312 are layered or stacked on each other in a vertical direction such that the actual images do not overlap (e.g., boundary edges of each image do not overlap) when viewed from the upper surface 10 of the display device 1. This configuration of the graphical images minimizes illumination unevenness of the graphical image being displayed (i.e., either image 200a or image 200b) when the display device 1 is actuated.

The material of the absorbing polarized film layer 312 is not particularly limited and may have transparent, opaque and light blocking sections and may come in a single color or a variety of colors to enhance the visual effect when the graphical images are displayed on the upper surface 10 of the display device 1. The materials of the diffusion layer 314 and the smoke layer 316 are also not particularly limited and may have characteristics suitable to enhance the display of the various graphical images described above to improve the quality of the image seen by the operator on the display device 1.

While three layers of the first polarized film section 310 are shown for illustration purposes, it is contemplated that a single absorbing polarized film layer could be provided or four or more layers could be provided (including additional interchangeable absorbing polarized film layers including graphical images, protective film layers, color enhancing film layers, or any additional film layers that control light transmission, reflection and refraction to enhance the images being displayed). In addition, it is contemplated that the first polarized film section 310 of the display device 1 described above may also generally incorporate the various multiple film layers of the first polarized film section 310. Further, it is contemplated that the graphical images 200a, 200b included on the absorbing polarized film layer 312 may be printed or laser etched thereon, or a non-polarized section of the film layer itself. It is contemplated that any other known method or combination of known methods for creating an image on a polarized film may also be employed.

As shown in FIG. 2A, each graphical image 200a, 200b of the absorbing polarized film layer 312 has a film layer polarization orientation 202a, 202b that is offset 90° from the film layer polarization orientation of the other film layer. In particular, the film layer on which the graphical image 200a is included has a film layer polarization orientation 202a at 0° and the film layer on which the graphical image 200b is included has a film layer polarization orientation 202b at 90°.

FIG. 2B shows a partial plan view of the second polarized film section 320. As described above, the second polarized film section 320 includes the first absorbing polarized film 322 having a first polarization orientation 322a at 0° and the second absorbing polarized film 324 having a second polarization orientation 324a oriented 90° from the first polarization orientation 322a of the first absorbing polarized film 322. As shown in FIG. 2A, the first and second absorbing polarized films 322, 324 are disposed along a plane perpendicular to a center axis of the display device 1 at a position below the first polarized film section 310.

When the display device 1 is actuated, the LED light 332 corresponding to the first absorbing polarized film 322 (at first polarization orientation 322a) and the LED light 332 corresponding to the second absorbing polarized film 324 (at second polarization orientation 324a) are alternately and repeatedly turned ON and OFF. When light passes through the first absorbing polarized film 322 (having first polarization orientation 322a at 0°), since the film layer including the graphical image 200a also has a polarization orientation 202a at 0°, the film layer including graphical image 200b (having a polarization orientation at 90° relative to the polarization orientation of the first absorbing polarized film 322) is displayed on the upper surface 10 of the display device 1.

When light passes through the second absorbing polarized film 324 (having second polarization orientation 324a at 90°), since the film layer including the graphical image 200b also has a polarization orientation 202b at 90°, the film layer including the graphical image 200a (having a polarization orientation at 0° and offset 90° relative to the polarization orientation of the second absorbing polarized film 324) is displayed on the upper surface 10 of the display device 1. Put another way, when the polarization orientation 322a of the first absorbing polarized film 322 is aligned with the polarization orientation of the film layer including the graphical image 200a (i.e., both film layers are oriented at 0°), the light is allowed to pass through both layers unimpeded such that the graphical image 200a is blocked from view on the upper surface 10 of the display device 1 and graphical image 200b is displayed (since the light can only pass through the non-polarized graphical image portion of the graphical image 200b film layer). Similarly, the graphical image 200b is blocked from view when the polarization orientation 324a of the second absorbing polarized film 324 is aligned with the polarization orientation of the film layer including the graphical image 200b. Here, the light is allowed to pass through both aligned layers and blocked by the polarized portion of the film layer including the graphical image 200a (which is oriented 90° from the film layer including graphical image 200b) such that graphical image 200a is displayed (i.e., the light can only pass through the non-polarized graphical image portion of the graphical image 200a film layer).

This arrangement changes the polarized direction of the light source 330 so as to allow the graphical images 200a, 200b to be alternately and repeatedly displayed on the upper surface 10 of the display device 1 in an animation-like manner, thus minimizing the intense blinking and flashing light of conventional designs. Due to the alternating and repeating transition between both graphical images, the animation-like setting allows operators to more easily view the actuation and/or state of the vehicle function while minimizing any possible negative impact to the operator. Such a configuration also enables the display device 1 to alternately and repeated display both graphical images on the display device 1 in a manner that minimizes distraction to the operator while clearly displaying the vehicle function and/or state of the vehicle function to the operator.

Moreover, the display device 1 is configured in this manner to eliminate the distracting blinking and flashing of light associated with conventional hazard light button technologies which have been known to negatively impact the health of drivers and passengers (e.g., blinking and flashing indicators have been known to raise the risk of triggering an epileptic episode experienced by the driver or passenger). Accordingly, the negative impact on drivers and passengers caused by distracting flashing and blinking indicators is minimized. The configuration also provides the operator with a fresh appearance that allows the operator to not only notice and recognize the activated vehicle function, but also to be aware of the activated vehicle function without being distracted (e.g., minimizing glare and/or reflection off of other interior parts of the vehicle such as the dashboard, touch screen, windows, rearview mirrors, upholstery, etc. . . . ) during daytime and nighttime driving, or even while parked.

In embodiments, it is contemplated that the display device 1 could be implemented, for example, as one or a combination of a push button assembly, a rotary dial assembly, and a touch-type operation device. For example, while the display device 1 has been described above to repeatedly and alternately display the first graphical image 200a and the second graphical image 200b when actuated, it is contemplated that the polarized film assembly 300 and light source 330 can be implemented in a rotary dial assembly such that when the rotary dial is rotated the first graphical image 200a and the second graphical image 200b are repeatedly and alternately displayed on an upper surface of the rotary dial assembly as well. However, the disclosed display device is not so limited and those of ordinary skill in the art may implement the display device in other known actuation device and switch assemblies.

Accordingly, the display device described above enable vehicle functions to be more easily controlled and displayed in a way that improves driver/operator convenience while simplifying the device, reducing manufacturing costs, and minimizing repair.

While the display device has been described with reference to several exemplary embodiments, it is understood that the words that have been used are words of description and illustration, rather than words of limitation. Changes may be made within the purview of the appended claims, as presently stated and as amended, without departing from the scope and spirit of the rotary dial assembly in its aspects. Although the display device has been described with reference to particular means, materials and embodiments, the display device is not intended to be limited to the particulars disclosed; rather the described display device configurations should be considered to extend to all functionally equivalent structures, methods, and uses such as are within the scope of the appended claims.

Although the present specification may describe components and functions that may be implemented in particular embodiments with reference to particular standards and protocols, the disclosure is not limited to such standards and protocols. For example, components of the non-limiting embodiments of the various electrical circuits represent examples of the state of the art. Such standards are periodically superseded by equivalents having essentially the same functions. Accordingly, replacement standards and protocols having the same or similar functions are considered equivalents thereof.

The illustrations of the embodiments described herein are intended to provide a general understanding of the structure of the various embodiments. The illustrations are not intended to serve as a complete description of all of the elements and features of the disclosure described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The preceding description of the disclosed embodiments is provided to enable any person skilled in the art to make or use the present disclosure. As such, the above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A display device, comprising:
a polarized film assembly disposed in the display device and configured to control a selective displaying of a first graphical image and a second graphical image on the display device, wherein
when the display device is actuated, the polarized film assembly is illuminated such that the first graphical image and the second graphical image are repeatedly and alternately displayed on the display device.

2. The display device of claim 1, wherein
the display device further comprises:
at least one light source provided below the polarized film assembly and configured to pass light through the polarized film assembly, wherein
when the display device is actuated, the at least one light source is illuminated to repeatedly and alternately display the first graphical image and the second graphical image on the display device.

3. The display device of claim 2, wherein
the at least one light source is a first light source and a second light source, and
when the display device is actuated, the first light source and the second light source are repeatedly and alternately illuminated to repeatedly and alternately display the first graphical image and the second graphical image on the display device.

4. The display device of claim 1, wherein
the polarized film assembly comprises:
a first polarized film section; and
a second polarized film section, wherein
the first polarized film section is spaced from the second polarized film section along a height direction of the display device,
the first polarized film section is a multilayer film and includes at least two absorbing polarized film layers, each film layer including one of the plurality of graphical images, each film layer having a film layer polarization orientation and each film layer polarization orientation being oriented 90° from another film layer polarization orientation of another film layer, the first polarized film section being stacked along the height direction of the display device,
the second polarized film section includes a first absorbing polarized film having a first polarization orientation and a second absorbing polarized film having a second polarization orientation oriented 90° from the first polarization orientation of the first absorbing polarized film, the first and second absorbing polarized films being disposed along a plane bisecting the polarized film assembly at a position below the first polarized film section, and
when the display device is actuated, the first polarized film section is repeatedly and alternately illuminated such that the graphical images included on the absorbing polarized film layers are repeatedly and alternately displayed on the display device.

5. The display device of claim 1, wherein
the polarized film assembly is configured to prevent boundary edges of each of the first graphical image and the second graphical image from overlapping one another when viewed from an upper surface of the display device.

6. The display device of claim 1, wherein
the first graphical image and the second graphical image are superimposed on each other in a concentric manner when viewed from an upper surface of the display device.
